(19) United States
(12) Patent Application Publication
(10) Pub. No.: US 2013/0080990 A1
(43) Pub. Date: Mar. 28, 2013

(54) METHOD OF REDUCING POWER LEAKAGE OF INTEGRATED CIRCUIT

(71) Applicant: HANS RAJ SINGH, Noida (IN)

(72) Inventor: HANS RAJ SINGH, Noida (IN)

(73) Assignee: FREESCALE SEMICONDUCTOR, INC, Austin, TX (US)

(21) Appl. No.: 13/245,888

(22) Filed: Sep. 27, 2011

(51) Int. Cl. G06F 17/50

(52) U.S. Cl. 716/133

(57) ABSTRACT

A method and system for performing power leakage reduction for an integrated circuit (IC) in a Virtual Multi-mode Multi-corner set up. Multiple view of the IC design data are analyzed in parallel to determine which low threshold voltage cells (LTVC) may be replaced with high threshold voltage cells (HVTC). A second analysis is performed that combines the analyses of each of the analyzed views and the IC design data is updated, where all of the LTVCs having positive slack time in all of the plurality of views are replaced with HTVCs.

### BACKGROUND OF THE INVENTION

The present invention relates generally to integrated circuit design, and more specifically, to multi-mode, multi-corner power leakage reduction of the integrated circuit.

Integrated circuits (ICs) are commonly used in portable devices. One requirement for use in portable devices is low power consumption in order to preserve the charge in the battery that provides power to the device. Thus, it is important to reduce power leakage in the IC. For purposes of power leakage reduction, the IC may be divided into cells that are essentially logical divisions of the IC.

Cells may be classified on the basis of threshold voltage. For example, the IC may have R, H, V, and Z types of cells, R being the cells having the lowest threshold voltage and Z being the cells with the highest threshold voltage. The H and V cells have threshold voltages higher than that of an R cell and lower than that of a Z cell. For ease of explanation, a cell is considered either a High Threshold Voltage Cell (HTVC) or a Low Threshold Voltage Cell (LTVC).

It is well known that a HVTC leaks less power than a LVTC. Therefore, one method to reduce power leakage is to minimize the number of LTVCs and replace them with HTVCs. However, replacement of LTVCs with HTVCs causes time delay problems because HTVCs have a higher time delay than LVTCs. Therefore, to achieve the two targets of low power leakage and low time delay, it is essential to maintain an optimal balance between the numbers of LTVCs and HTVCs present in the integrated circuit. To determine this optimal balance, a detailed and efficient analysis of the IC design is necessary. However, there are several limitations in the existing methods and systems that perform such detailed analysis. For example, a detailed analysis takes a long time to perform due to the large number of cells in present day ICs. Sometimes the time necessary to perform the analysis may run into several days.

Another problem is the lack of any systems and methods to optimize the IC at the last stage of the design cycle. For example, if any unwanted power leakage or timing constraint violation is found at the last stage of the design cycle, it is very difficult to analyze the violation due to the large amount of time required. The unwanted power leakage or timing constraint violation at the last stage of the design cycle may arise for several reasons including an inadvertent error or a last minute design change.

The problem is further complicated by the interdependencies among cells. A cell has a functional dependency relationship with many, if not all, of the other cells of the IC. Thus, replacing a cell with a cell having different characteristic parameters such as threshold voltage at one point in the IC may produce an undesired result in another other point in the IC. Thus, it is necessary to take into account all of these dependencies before replacement of any cells is attempted.

Present day ICs have multiple modes and multiple corners. The IC must be analyzed at all of these modes and corners. As the number of modes and corners increases, the time required for this analysis also increases.

As used herein, the term “view” means a mode, a corner, or a combination of a mode and a corner of the IC. A view may be defined as a set of conditions to be met by the IC. Analyzing the IC for a mode or corner may be thought of as testing a view of the IC. If there are two modes and three corners, then there will be a total of six views (i.e., 2×3). If the number of modes and corners is doubled to four modes and six corners, then there will be 24 views (i.e., 6×4). Thus, the number of views to be analyzed increases rapidly with the increase in the number of modes and corners.

Thus, there is a need for a system and method for quickly and efficiently analyzing IC design data, especially at the last stages of the design cycle, in order to assist in reducing power leakage of the IC.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a schematic block diagram of an exemplary environment in which various embodiments of the present invention can be practiced;

FIG. 2 is a schematic block diagram illustrating data flow among system elements for performing automated virtual multi-mode multi-corner power leakage optimization for an integrated circuit in accordance with an embodiment of the present invention;

FIG. 3 is a schematic block diagram illustrating an exemplary primary module in accordance with an embodiment of the present invention;

FIG. 4 is a schematic block diagram illustrating an exemplary secondary module in accordance with an embodiment of the present invention; and

FIG. 5 is a flowchart illustrating an exemplary method for automated virtual multi-mode multi-corner power leakage optimization for the integrated circuit in accordance with an embodiment of the present invention.

### DETAILED DESCRIPTION OF THE INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

The present invention provides a system and method for performing virtual, automated multi-mode and multi-corner power leakage reduction of an integrated circuit (IC).

In an embodiment of the present invention, design data of the IC is provided to a plurality of computer resources, such as by providing each of the plurality of computing resources with an address of the location of the design data in a network of the plurality of computing resources. Each of the plurality of computing resources generates a separate and independent view of the design data for analysis.

In an embodiment of the present invention, multi-mode multi-corner power leakage optimization of an IC is performed in two stages. At a first stage a plurality of first analyses are performed and at a second stage, a second analysis is performed. The first analyses include performing an analysis for each view of the IC i.e., one analysis is carried out for each view. Interdependencies among different views are then removed. In other words, the system analyzes a view of the IC independently of other views. At the first stage of analysis, no data is exchanged among the first analyses to ensure that all of the views are analyzed accurately and efficiently. Output of the plurality of first analyses comprises information regarding timing constraints and possible cell replacements in the plurality of different views.

At the second stage of the analysis, the output from the plurality of first analyses is combined by performing various operations such as intersection and union. Output of the second analysis is used for identifying cells of the IC that may be replaced. In one embodiment of the present invention, all the LTVCs having positive slack time in all of the views are replaced with HTVCs.

The system and method of the present invention reduces the time taken for analyzing the IC design data and increases efficiency of including LTVCs. The system and method of the present invention when tested yielded results summarized in table 1.

Table 1 shows that with the system and method of the present invention recovery (i.e., replacement of LTVCs with HTVCs) percentage of LTVCs (Gain % R) is 38% for a memory design and 60% for an SOC design. In other words, for the memory design, 38% of the LTVCs can be replaced with HTVCs. Gain % H is −31% for the memory design, which means that there is a 31% increase in number of type ‘H’ cells. It may be noted in context of the data in table 1, that, a positive Gain number for one type of cells signifies a reduction in number of that type of cells and a negative Gain number signifies an increase in number of that type of cells.

TABLE 1

| Test case | memory design | SOC design |
|---|---|---|
| Instance Count (in | 0.2 | 2.46 |
| millions ) | | |
| Memory Usage (in | 215 | 376 |
| Mbytes) | | |
| CPU time (in seconds) | 10000 | 17000 |
| Views | 1 | 4 |
| Gain % R | 38 | 60 |
| Gain % H | −31 | 43 |
| Gain % V | 21 | −38 |

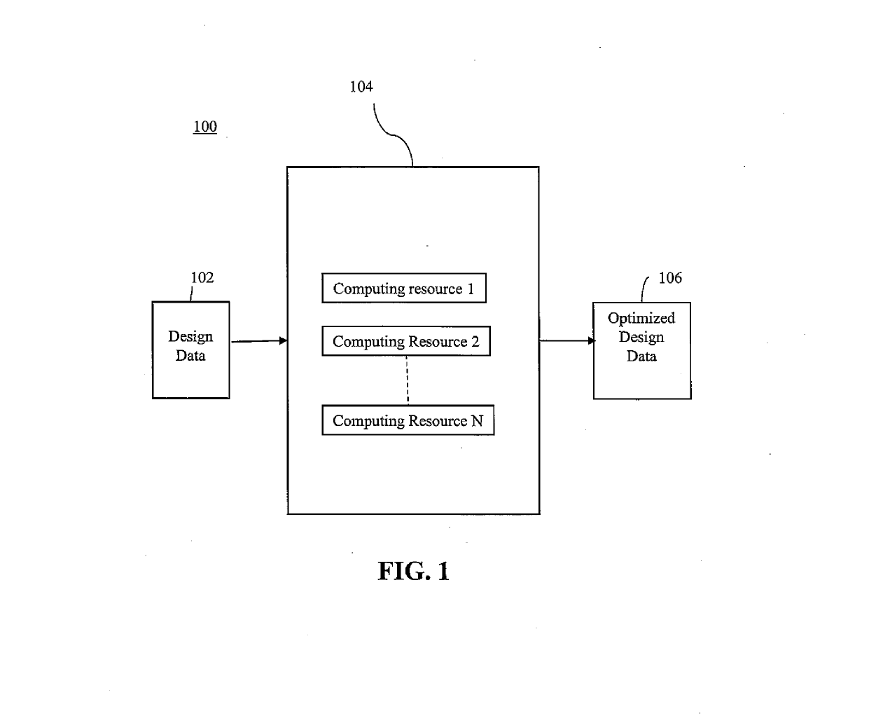

Referring now to FIG. 1, a computer system in which various embodiments of the present invention can be practiced is shown. The computer system 100 comprises IC design data 102; a plurality of computing resources 104, and optimized design data 106. The plurality of computing resources 104 comprises N computing resources, wherein N is a natural number. Only three of the plurality of computing resources namely, computing resource 1, computing resource 2, and computing resource N are shown for the sake of brevity. The plurality of computing resources 104 processes the design data 102 to generate the optimized design data 106. The computing resources 104 may comprise individual computers or processors, such as computer systems used for integrated circuit design that run the Linux operating system, that are coupled to each other for communication.

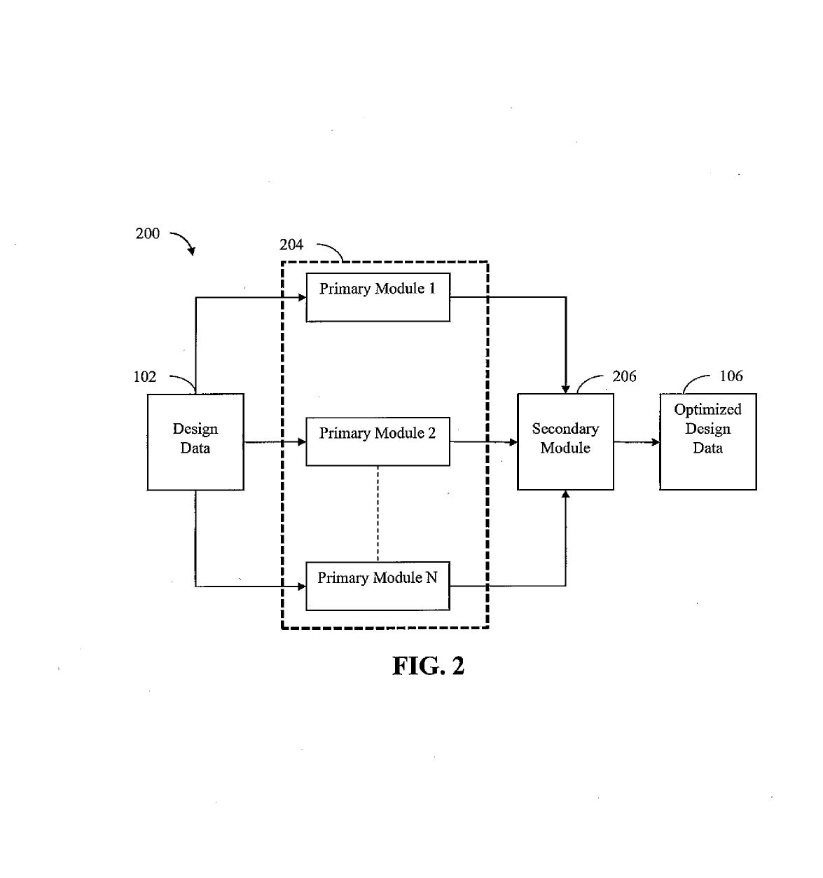

FIG. 2 is a block diagram illustrating the flow of the design data 102 in a computer system 200 that performs multi-mode, multi-corner power leakage optimization for an IC in accordance with an embodiment of the present invention. The system 200 comprises a plurality of primary modules 204 and a secondary module 206. Each of the plurality of primary modules 204 resides on a separate and independent computing resource of the plurality of computing resources 104 (FIG. 1). For example, primary module 1 resides on the computing resource 1; primary module 2 resides on the computing resource 2, and so on. The secondary module resides on a final computing resource. The final computing resource is randomly selected from the plurality of computing resources 104. The design data 102 is provided to each of the plurality of computing resources 104. At each of the plurality of computing resources 104, the design data 102 is processed independently of the other computing resources 104.

The plurality of primary modules 204 generates a plurality of first analyses. More specifically, each of the primary modules 204 generates an analysis for one of the views of the IC design data 102. Each of the plurality of analyses generated by the primary modules 204 are provided to the secondary module 206. The secondary module 206 combines the first analyses and identifies LTVCs within the IC design data 102 that may be replaced with HVTCs. The LTVCs that may be replaced with HTVCs are identified as LTVCs that have positive slack time in all of the views (where all of the views are analyzed in parallel by the computing resources 104).

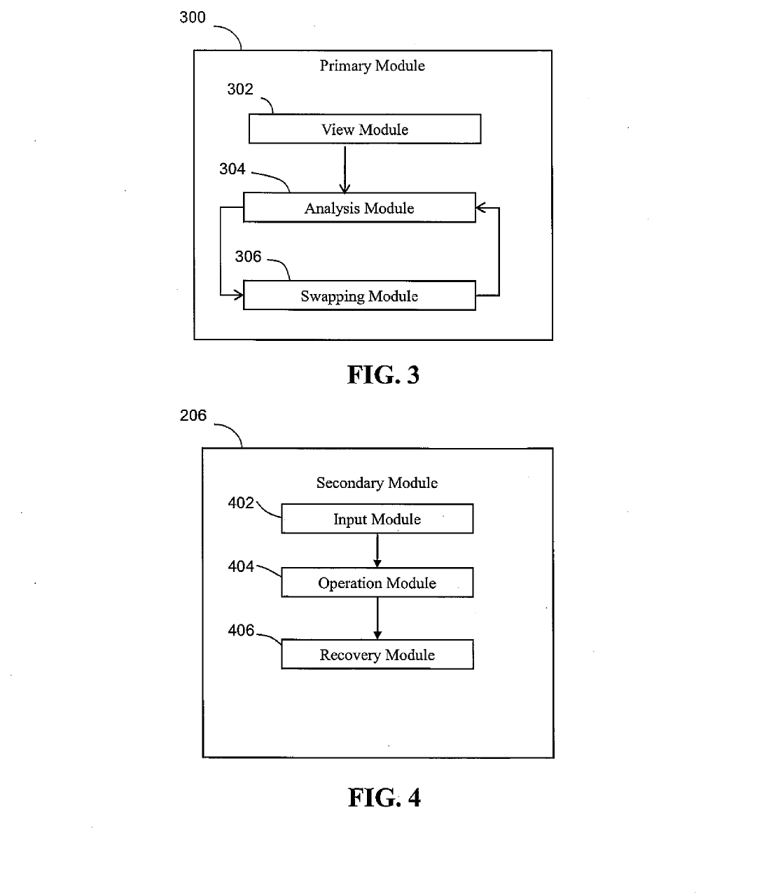

FIG. 3 is a block diagram illustrating a primary module 300 in accordance with an embodiment of the present invention. The internal structure of the primary module 300 represents the internal structure of each of the plurality of primary modules 204. The primary module 300 comprises a view module 302, an analysis module 304, and a swapping module 306. The view module 302 generates view data for a view of the IC based on the IC design data 102. The view comprises a mode, a corner, or a combination of a mode and a corner of the IC. The view module 302 provides the view data to the analysis module 304. The analysis module 304 performs timing analysis on the view data and provides timing information to the swapping module 306. The swapping module 306 performs swapping of LTVCs and HTVCs and generates swapping information that it provides back to the analysis module 304. In one embodiment of the invention, the swapping is performed in a burst mode where a plurality of LVTCs is substantially simultaneously swapped with HVTCs.

The analysis module 304 performs timing analysis again using the swapping information. If timing constraints are not met some of the swapped HTVCs are changed back (reverted) to LTVCs and this process reiterates until timing constraints are met. This process of swapping and reverting of LTVCs and HTVCs is performed for each of the plurality of views by the plurality of primary modules 204 executing on the computing resources 104. When the timing constraints for each of the views have been met, the final swapping information (i.e., updated IC design data for each view) is passed to the secondary module 206.

FIG. 4 is a block diagram illustrating the secondary module 206 in accordance with an embodiment of the present invention. The secondary module 206 comprises an input module 402, an operation module 404, and a recovery module 406. The input module 402 receives the final swapping information IC data from the plurality of primary modules 204. More particularly, timing information generated by the analysis modules 304 and the swap information generated by the swapping modules 306 are received by the input module 402. The input module 402 collates all the data received from the plurality of primary modules 204 and the collated data is provided to the operation module 404. The operation module 404 analyzes the timing and swapping information and identifies cells of the integrated circuit that may be replaced and provides the information of cells that may be replaced to the recovery module 406. In one embodiment of the present invention, the recovery module 406 replaces all the LTVCs having positive slack time in all of the plurality of views with HTVCs.

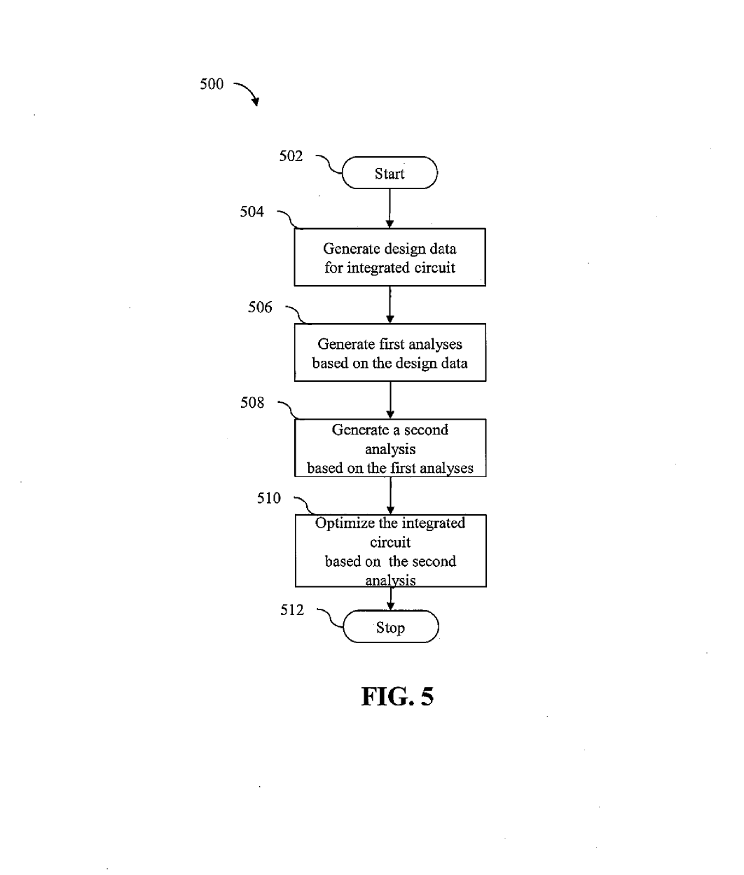

FIG. 5 is a flowchart illustrating an exemplary method for automated virtual multi-mode multi-corner power leakage optimization for an IC in accordance with an embodiment of the present invention. At step 504, IC design data is generated in a manner known to those skilled in the art. For example, IC design data may comprise structural net lists, parasitic, timing information and other design constraints. At step 506, a plurality of first analyses is performed on the IC design data by the plurality of primary modules 204. As previously noted, each of the plurality of first analyses is performed by one of the plurality of primary modules 204 independently of and preferably in parallel with the other primary modules 204. Also as previously discussed, each primary module 204 analyzes one view of the IC design data and swaps LVTCs with HVTCs, runs a timing analysis using the data including the swapped cells, and then re-iterates this process until timing constraints have been met.

At step 508, a second analysis is generated based on the plurality of first analyses. The second analysis is generated by the secondary module 206 residing on the final computing resource. In one embodiment of the present invention, the final computing resource is randomly selected from the plurality of computing resources 104. In another embodiment of the present invention, the final computing resource is an outside computing resource not included in the plurality of computing resources 104. The second analysis analyzes the data generated by each of the primary modules at step 506 and determines which LTVCs in the IC design data may be swapped with HVTCs. In one embodiment of the invention, the LTVCs that may be swapped with HVTCs are those that were swapped in each of the various views and for which all of the various views passed the timing constraints. In one embodiment of the invention, combining of different results from each individual analysis is performed one or two ways.

One is union and second is intersection. In union, all those cells that were changed from LVT to HVT are concatenated and then unified. In intersection only those cells that are in the results of all of the views are considered as final output. Such union and intersection operations should be understood by those of skill in the art as they are well known in set theory mathematics.

At step 510, the IC design data is optimized based on the second analysis. In one embodiment of the invention, the IC design data is updated to include the swapped cells by altering the mask layer data so that the cell changes are implemented at the mask layer.

The method for performing multi-mode multi-corner power leakage optimization, as described in the present invention, may be implemented in software stored on a computer readable medium and executed on a computer system. Typical examples of a computer system include a general-purpose computer, a programmed microprocessor, a micro-controller, a peripheral integrated circuit element, and other devices or arrangements of devices that are capable of implementing the steps that constitute the method of the present invention. The computer readable medium may, for example, be RAM, ROM, EPROM, a flash drive, CD-ROM, etc.

The software is set of instructions that may include various commands that instruct the processors to perform specific tasks such as the steps that constitute the method of the present invention. The set of instructions may be in the form of a software program, such as application software. Further, the software might be in the form of a collection of separate programs, a program module with a larger program or a portion of a program module. The software might also include modular programming in the form of object-oriented programming. The software program containing the set of instructions can be embedded in a computer program product for use with a computer, the computer program product comprising a computer readable medium having a computer readable program code embodied therein. The processing of input data by the processing machine may be in response to user commands, or in response to results of previous processing or in response to a request made by another processing machine.

The modules described herein may include processors and program instructions to implement the functions of the modules described herein. Some or all functions could be implemented by a state machine that has no stored program instructions, or in one or more application specific integrated circuits (ASICs), in which each function or some combinations of certain of the functions are implemented as custom logic.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method of reducing power leakage in an integrated circuit (IC) design defined by IC design data, the IC having a Virtual Multi-Mode Multi-Corner (Virtual MMMC) set up, the method comprising:
providing IC design data to each of a plurality of computing resources, wherein the IC defined by the design data is capable of operating in a number of modes and the IC may be manufactured having a plurality of design corners, wherein each mode and each corner comprises a view;
performing a plurality of first analyses of the design data using the plurality of computing resources, wherein each computer resource analyzes a different view of the IC and generates separate view data;
performing a second analysis based on the plurality of first analyses using a final computing resource, wherein the final computing resource analyzes all of the separate view data and swaps at least one low voltage threshold cell with a high voltage threshold cell; and
updating the IC design data based on the second analysis, the updated design data including the at least one swapped cell.

2. The method of claim 1, wherein the final computer resource comprises a randomly selected one of the plurality of computer resources.

3. The method of claim 1, wherein each of the plurality of first analyses comprises performing a first timing analysis.

4. The method of claim 3, wherein the first timing analysis comprises identifying one or more low threshold voltage cells of the IC having positive slack time.

5. The method of claim 4, further comprising swapping at least one of the one or more low threshold voltage cells having positive slack time with a high threshold voltage cell and saving as new view design data.

6. The method of claim 5, wherein the swapping is performed in a burst mode, wherein the burst mode comprises substantially simultaneously swapping a plurality of low voltage threshold cells with high voltage threshold cells.

7. The method of claim 5, further comprising performing a second timing analysis on the new view design data.

8. The method of claim 7, further comprising reverting the swapping of the at least one low voltage threshold cell if the swapping causes the second timing analysis to fail.

9. The method of claim 8, wherein in the second analysis, the at least one swapped low threshold voltage cell has positive slack time in each of the plurality of views.

10. The method of claim 1, wherein swapping the at least one low threshold cell is performed at a mask layer of the integrated circuit.

11. A computer implemented system for performing power leakage optimization for an integrated circuit in a Virtual Multi-Mode Multi-Corner (Virtual MMMC) set up, the system comprising:
a generating module configured for generating design data for the integrated circuit;
a plurality of primary modules configured for performing a plurality of first analyses, wherein each of the plurality of first analyses is performed using a separate and independent primary module of the plurality of primary modules; and
a secondary module configured for performing a second analysis based on the plurality of first analyses.

12. The system of claim 10, wherein the view module generates a view of the integrated circuit based on the design data, wherein the view comprises one of a mode, a corner, and a combination of a mode and a corner of the integrated circuit.

13. The system of claim 12, wherein the analysis module performs a timing analysis and provides timing data to the swapping module.

14. The system of claim 12, wherein the swapping module swaps low threshold voltage cells and higher threshold voltage cells of the integrated circuit based on the timing data.

15. The system of claim 11, wherein the secondary module comprises an input module, an operation module, and a recovery module.

16. The system of claim 15, wherein the input module transfers the timing data and swap information received from the analysis module and swapping module respectively to the operation module.

17. The system of claim 15, wherein the operation module provides recovery information to the recovery module based on intersection and union operations performed on the timing data and swap information.

18. The system of claim 15, wherein the recovery information comprises a list of cells having positive slack time in all of the views.

19. The system of claim 18, wherein the recovery module recovers all of the cells in the list.

20. A computer program product for use with a computer, the computer program product comprising a non-transitory computer usable medium having a computer readable program code embodied therein for performing power leakage optimization for an integrated circuit in a Virtual Multi-Mode Multi-Corner (Virtual MMMC) set up, the computer readable program code having instructions for:
generating design data for the integrated circuit having a plurality of modes and a plurality of corners, wherein generating the design data comprises generating a plurality of views of the integrated circuit;
providing the design data to each of a plurality of computing resources;
performing a plurality of first analyses of the design data using the plurality of computing resources, wherein each of the plurality of first analyses is performed by a separate and independent computing resource randomly selected from the plurality of computing resources;
performing a second analysis based on the plurality of first analyses using a final computing resource, wherein the final computing resource is randomly selected from the plurality of computing resources; and
recovering at least one low threshold voltage cell of a plurality of cells of the integrated circuit based on the second analysis.
